(19) United States
(12) Patent Application Publication
(10) Pub. No.: US 2023/0103818 A1
(43) Pub. Date: Apr. 6, 2023

(54) PASTING DEVICE FOR REDUCING WIND RESISTANCE OF BICYCLE

(71) Applicant: Mu-Rong Li, TAICHUNG CITY (TW)

(72) Inventor: Mu-Rong Li, TAICHUNG CITY (TW)

(21) Appl. No.: 17/494,786

(22) Filed: Oct. 5, 2021

(51) Int. Cl. B62D 35/00

(52) U.S. Cl. CPC B62D 35/00

(57) ABSTRACT

A pasting device for reducing wind resistance of a bicycle is disclosed. The pasting device includes a pasting body; a side of the pasting body is a pasting side, and other side of the pasting body is a windward side, and the pasting body includes a pasting layer disposed on the pasting side, and a plurality of granular parts protruded on the windward side. The plurality of granular parts can form a diversion effect to reduce wind resistance when the bicycle is traveling windward.

### BACKGROUND OF THE INVENTION

### 1. Field of the Invention

The present invention relates to a technical field of bicycle equipment, and more particularly to a pasting device for reducing wind resistance of a bicycle.

### 2. Description of the Related Art

The bicycle industry in Taiwan has greatly grown in recent years. Many large bicycle manufacturers have gradually moved from daily commuting product markets to high-unit-price product markets. One of the high-unit-price product markets is the racing sport bicycle market.

The requirement for high-unit-price bicycles has changed from the feature of light weight in the past to the features of both light weight and low wind resistance currently, in order to improve a speed of the sport bicycle.

During the process of riding a bicycle, the biggest source of resistance is air resistance, which is generally called wind resistance, so relevant manufacturers made effort to improve the structure of the bicycle or change the appearance of the bicycle tube shape to minimize the air resistance during riding, in order to achieve a higher exercise efficiency and a wind-breaking effect at speed.

However, the changes in the appearances and shapes of the bicycle tubes affect the original manufacturing equipment and process, so the bicycle manufacturers need to invest more in the replacement of equipment or new equipment.

Therefore, how to achieve the effect of reducing the wind resistance without changing the existing structure of the bicycle tube is a direction of the bicycle manufacturer's effort, and the present invention is working towards this goal.

### SUMMARY OF THE INVENTION

An objective of the present invention is to provide a pasting device which can be directly pasted and combined on a tube of an exist bicycle to reduce wind resistance when the bicycle is traveling, and utilizing the pasting device of the present invention does not need to change the existing structure of the bicycle tube and is able to be in cooperation with the existing shape of the bicycle tube, so as to achieve the effect of improving an exercise efficiency and a riding speed.

In order to achieve the above-mentioned objective and effect, the present invention discloses a pasting device for reducing wind resistance of a bicycle, and the pasting device includes a pasting body, a side of the pasting body is a pasting side, and other side of the pasting body is a windward side, and the pasting body includes a pasting layer disposed on the pasting side, and a plurality of granular parts protruded on the windward side.

Therefore, the plurality of granular parts can form a diversion effect to reduce wind resistance when the bicycle is traveling windward, so as to reduce wind resistance of a bicycle when the bicycle is travelling.

### BRIEF DESCRIPTION OF THE DRAWINGS

The structure, operating principle and effects of the present invention will be described in detail by way of various embodiments which are illustrated in the accompanying drawings.

FIG. 1 is a perspective view of a pasting device of the present invention.

FIG. 2 a schematic view of an application of a pasting device of the present invention.

FIG. 3 is a schematic cross-sectional view taken along of FIG. 2, according to the present invention.

FIG. 4 is a schematic view showing that air flows form a diversion effect when a bicycle is traveling, according to the present invention.

FIG. 5 is a schematic cross-sectional view of another embodiment of a pasting device of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

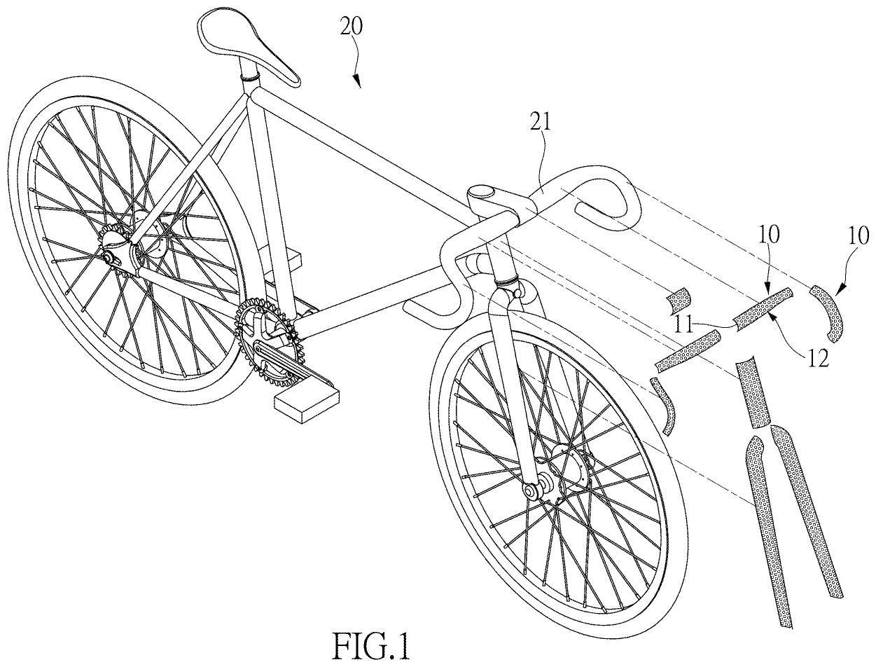

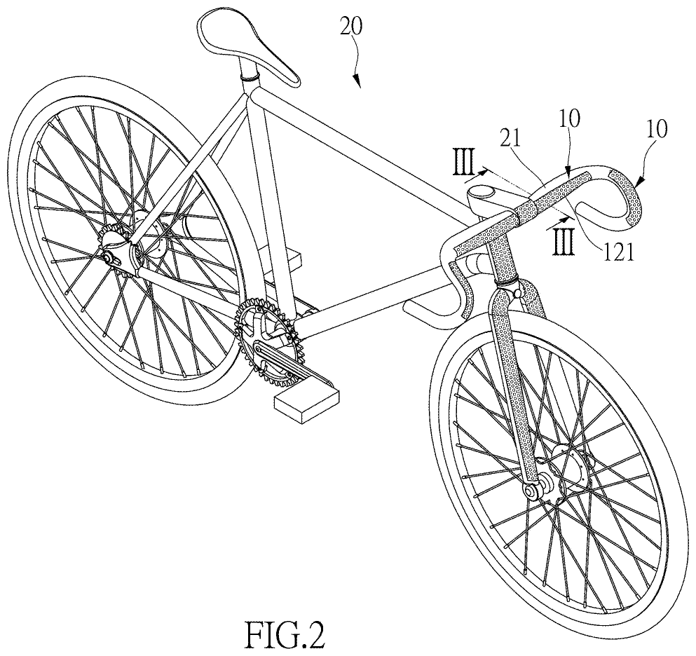

Please refer to FIGS. 1 to 4, which show a pasting device for reducing wind resistance of bicycle, according to the present invention. As shown in FIGS. 1 to 4, the pasting device includes a pasting body 10, a side of the pasting body 10 is a pasting side 11, and the other side of the pasting body is a windward side 12. The pasting body 10 includes a pasting layer 111 disposed on the pasting side 11 thereof, and a plurality of granular parts 121 protruded on the windward side 12 thereof.

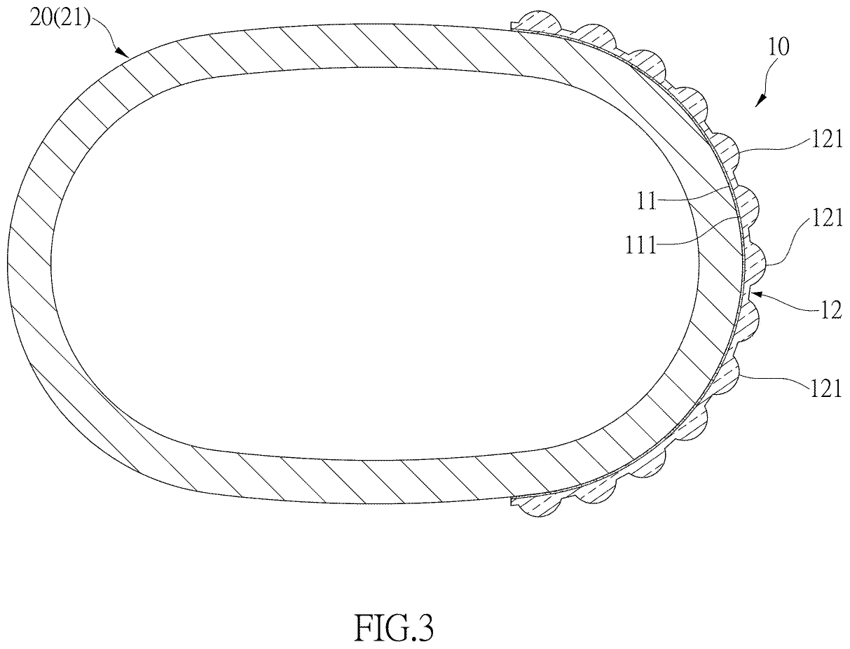

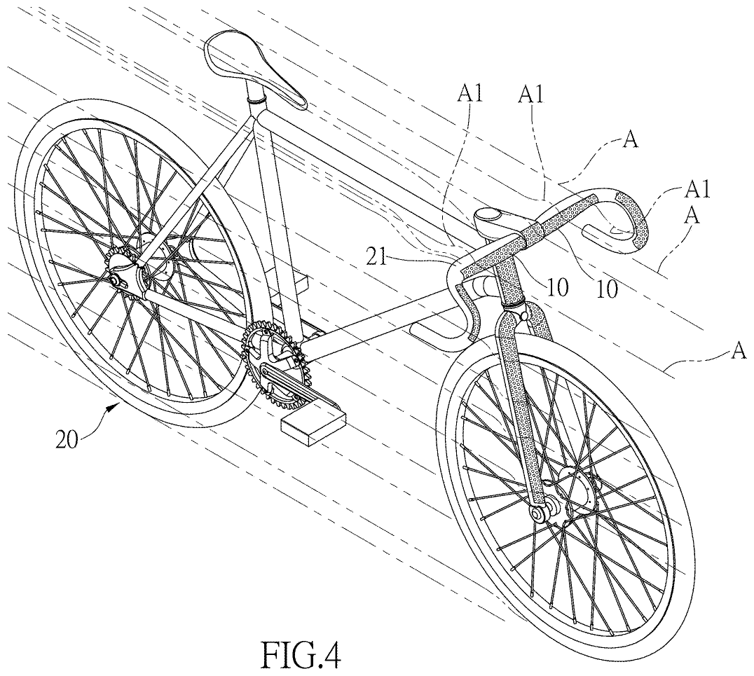

As shown in FIGS. 1 to 4, when in use, the pasting layer 111 of the pasting side 11 of the pasting body 10 is pasted on a windward member 21 of a bicycle 20; for example, as shown in FIG. 3, the pasting layer 111 can be pasted on a handle of the bicycle 20. The plurality of granular parts 121 protruded on the windward side 12 of the pasting body 10 can face toward a travelling direction of the bicycle 20, so that the plurality of granular parts 121 are windward when the bicycle 20 is travelling; as shown in FIG. 4, when the bicycle 20 is travelling, the air flow A flowing through the pasting body 10 (such as the line connected between two points shown in FIG. 4) can form a diversion effect A1 by means of the plurality of granular parts 121, so as to reduce wind resistance when the bicycle 20 is travelling.

The objective and implementation of the present invention are described in detail with reference to the above-mentioned contents including the main technical features of the embodiment of the present invention and corresponding to the spirit and scope of the disclosure set forth in the claim 1; the technical feature of the dependent claim is a detailed description of the technical feature of the claim 1 or an additional technical feature, and is not intended to limit the scope of the claim 1. It should be noted that the scope of the claim 1 is not necessary to includes the technical features of the dependent claims.

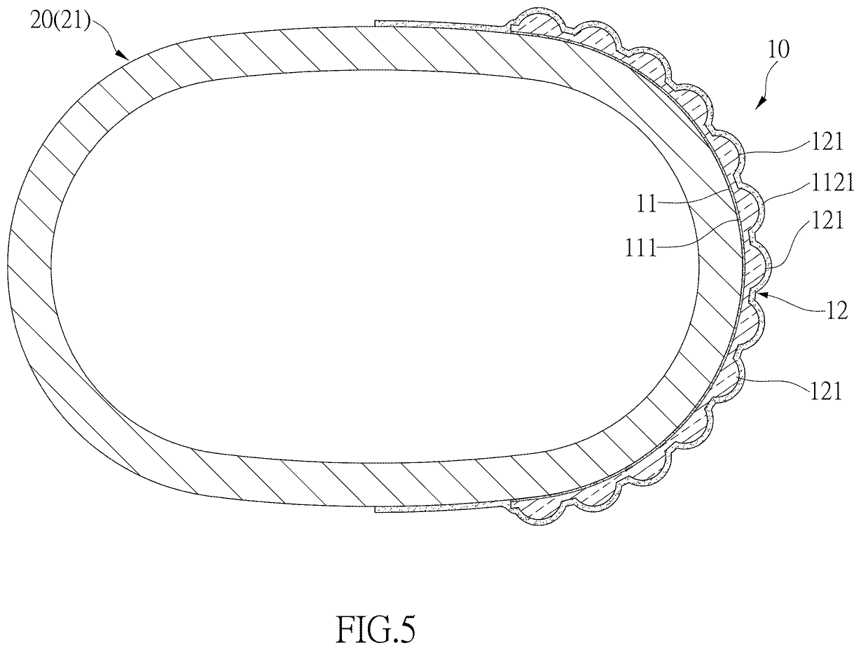

The features of components of the pasting device of the present invention are described in detail in the following paragraphs. As shown in another embodiment of FIG. 5, a baking paint layer 1211 can be attached on the plurality of granular parts 121 on the windward side 12 of the pasting body 10, so that the baking paint layer 1211 can provide an external protection effect for the plurality of granular parts 121 to prevent wearing or collision injury.

Furthermore, the pasting body 10 can be made by a transparent material.

As described above, the present invention can achieve the following advantages by means of the plurality of granular parts 121 protruded on the windward side 12 of the pasting body 10.

First, the pasting device of the present invention can be directly pasted and combined on the windward member 21 of the bicycle to reduce the wind resistance when the bicycle 20 is travelling, and utilizing the pasting device of the present invention does not need to change the tube shape of the bicycle 20.

Secondly, the effect of improving higher exercise efficiency and travelling speed can be achieved.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A pasting device for reducing wind resistance of a bicycle, comprising:
a pasting body, wherein a side of the pasting body is a pasting side, and other side of the pasting body is a windward side, and the pasting body comprises a pasting layer disposed on the pasting side thereof, and a plurality of granular parts protruded on the windward side thereof;
wherein the plurality of granular parts form a diversion effect to reduce wind resistance when the bicycle is travelling windward.

2. The pasting device according to claim I, wherein the pasting body comprises a baking paint layer attached and combined on the windward side of the pasting body, and the baking paint layer is attached on the plurality of granular parts and configured to provide an external protection effect.

3. The pasting device according to claim 2, wherein the pasting body is made by a transparent material.
